(19) United States
(12) Patent Application Publication
(10) Pub. No.: US 2009/0046181 A1
(43) Pub. Date: Feb. 19, 2009

(54) Method and apparatus providing improved successive approximation analog-to-digital conversion for imagers

(75) Inventors: Espen A. Olsen, Irvine, CA (US); Sanjayan Vinayagamoorthy, Pasadena, CA (US)

Correspondence Address: DICKSTEIN SHAPIRO LLP, 1825 EYE STREET, NW, WASHINGTON, DC, 20006, US

(73) Assignee: MICRON TECHNOLOGY , INC.

(21) Appl. No.: 11/889,521

(22) Filed: Aug. 14, 2007

(51) Int. Cl. H04N 9/04

(52) U.S. Cl. 348/265; 348/E09.01

(57) ABSTRACT

A method for performing successive approximation analog-to-digital conversions in an imaging device. Analog-to-digital converters connected to the columns of pixels in the imager are initially grouped. Depending on the column or group the analog-to-digital converter is associated with, a different respective portion of a digital code corresponding to the analog pixel signals input from the respective column undergoes conversion in a manner that substantially reduces capacitive loading within each analog-to-digital converter.

### FIELD OF THE INVENTION

Embodiments of the invention relate to imagers and more particularly to analog-to-digital conversion techniques for imagers.

### BACKGROUND

A CMOS imager includes a focal plane array of pixel circuits, each one of the pixels including a photosensor, for example, a photogate, photoconductor or a photodiode overlying a substrate for accumulating photo-generated charge in the underlying portion of the substrate. Each pixel has a readout circuit that includes at least an output field effect transistor formed in the substrate and a charge storage region formed on the substrate connected to the gate of an output transistor. The charge storage region may be constructed as a floating diffusion region. Each pixel may include at least one electronic device such as a transistor for transferring charge from the photosensor to the storage region and one device, also typically a transistor, for resetting the storage region to a predetermined charge level prior to charge transference.

In a CMOS imager, the active elements of a pixel perform the necessary functions of: (1) photon to charge conversion; (2) accumulation of image charge; (3) resetting the storage region to a known state; (4) selection of a pixel for readout; and (5) output and amplification of a signal representing pixel charge. The charge at the storage region is typically converted to a pixel output voltage by the capacitance of the storage region and a source follower output transistor.

CMOS imagers of the type discussed above are generally known as discussed, for example, in U.S. Pat. No. 6,140,630, U.S. Pat. No. 6,376,868, U.S. Pat. No. 6,310,366, U.S. Pat. No. 6,326,652, U.S. Pat. No. 6,204,524 and U.S. Pat. No. 6,333,205, assigned to Micron Technology, Inc.

FIG. 1 illustrates a block diagram for a CMOS imager 10. The imager 10 includes a pixel array 20. The pixel array 20 comprises a plurality of pixels arranged in a predetermined number of columns and rows. The pixels of each row in array 20 are all turned on at the same time by a row select line and the pixel signals of each column are selectively output onto output lines by a column select line. A plurality of row and column select lines are provided for the entire array 20.

The row lines are selectively activated by the row driver 32 in response to row address decoder 30 and the column select lines are selectively activated by the column driver 36 in response to column address decoder 34. Thus, a row and column address is provided for each pixel. The CMOS imager 10 is operated by the control circuit 40, which controls address decoders 30, 34 for selecting the appropriate row and column select lines for pixel readout, and row and column driver circuitry 32, 36, which apply driving voltage to the drive transistors of the selected row and column select lines.

Each column contains sampling capacitors and switches 38 associated with the column driver 36 that reads a pixel reset signal Vᵣₛₜ and a pixel image signal V_{sig} for selected pixels. A differential signal (e.g., Vᵣₛₜ-V_{sig}) is produced by differential amplifier 40 for each pixel and is digitized by analog-to-digital converter 100 (ADC). The analog-to-digital converter 100 supplies the digitized pixel signals to an image processor 50, which forms a digital image output.

The signals output from the pixels of the array 20 are analog voltages. These signals must be converted from analog to digital for further processing. Thus, the pixel output signals are sent to the analog-to-digital converter 100. In a column parallel readout architecture, each column is connected to its own respective analog-to-digital converter 100 (although only one is shown in FIG. 1 for convenience purposes). Many CMOS imagers use ramp analog-to-digital converters, which are essentially a comparator and associated control logic. In the conventional ramp analog-to-digital converter, an input voltage of the signal to be converted is compared with a gradually increasing reference voltage. The gradually increasing reference voltage is generated by a digital-to-analog converter (DAC) as it sequences through and converts digital codes into analog voltages. This gradually increasing reference voltage is known as the ramp voltage. In operation, when the ramp voltage reaches the value of the input voltage, the comparator generates a signal that latches the digital code of the DAC. The latched digital code is used as the output of the analog-to-digital converter.

One shortcoming of ramp analog-to-digital converters is that they must step through, one value at a time, all possible digital values that could be generated and output by the analog-to-digital converter. This is very time consuming. Accordingly, some imagers use successive approximation (also known as “SAR”) analog-to-digital converters instead of the ramp analog-to-digital converters. In a column parallel readout architecture, there is one successive approximation analog-to-digital converter for each column in the pixel array.

A conceptual diagram of a successive approximation analog-to-digital converter 100 is illustrated in FIG. 2. In the illustrated example, an N-bit digital code D₀, . . . , D_{N-1} representing the analog input voltage V_{IN} is output by the converter 100. Accordingly, the resolution of the analog-to-digital converter 100 is N bits wide. The illustrated analog-to-digital converter 100 comprises switches 102, 104, 108₀, 108₁, 108₂, 108₃, . . . 108_{N-1}, a plurality of capacitors 106₀, 106₁, 106₂, 106₃, . . . 106_{N-1}, a comparator 110 and a successive approximation register (SAR) 120. The capacitors 106₀, 106₁, 106₂, 106₃, . . . 106_{N-1} each have a different capacitance C, C/2, C4, C/8, . . . C/2^{N-1}, respectively. As can be seen, the first capacitor 106₀ has a capacitance C while each successive capacitor 106₁, 106₂, 106₃, . . . 106_{N-1} has a capacitance C/2, C4, C/8, . . . C/2^{N-1}, respectively, based on the first capacitor's capacitance C, but reduced by a factor of two. As such, the illustrated capacitors 106₀, 106₁, 106₂, 106₃, . . . 106_{N-1} are often collectively referred to as binary-weighted capacitors. In addition, the first capacitor 106₀ is often associated with the most significant bit (MSB) D₀ of the digital code D₀, . . . , D_{N-1} output by the converter 100.

A first terminal of each capacitor 106₀, 106₁, 106₂, 106₃, . . . 106_{N-1} is connected to a first line L1 that is connected at one end to an inverting input of the comparator 110. The other input of the comparator 110 is connected to a ground potential. It should be noted that the first line L1 (and thus, the first terminal of the capacitors 106₀, 106₁, 106₂, 106₃, . . . 106_{N-1}) can be connected to the non-inverting input of the comparator 110 and the ground potential or a positive potential can be connected to the inverting input of the comparator 110, if desired. In the illustrated example, the first switch 102 is connected at the second end of the first line L1. The first switch 102 is shown in a first state connecting the first line L1 to a ground potential. In a second state (not shown), the first switch disconnects the first line L1 from the ground potential. The first switch 102 is controlled by a first control signal S_{A} output by the successive approximation register 120.

Each capacitor 106₀, 106₁, 106₂, 106₃, . . . 106_{N-1} is also connected at one terminal to a respective associated switch 108₀, 108₁, 108₂, 108₃, . . . 108_{N-1}. The associated switches 108₀, 108₁, 108₂, 108₃, . . . 108_{N-1} are shown in a first state, connecting the second terminal of the capacitors 106₀, 106₁, 106₂, 106₃, . . . 106_{N-1} to a second line L2. In a second state, the associated switches 108₀, 108₁, 108₂, 108₃, . . . 108_{N-1} connect the second terminal of the capacitors 106₀, 106₁, 106₂, 106₃, . . . 106_{N-1} to ground. The associated switches 108₀, 108₁, 108₂, 108₃, . . . 108_{N-1} are respectively controlled by switch control signals S₀, S₁, S₂, S₃, . . . S_{N-1}, which are also output by the successive approximation register 120. An end of the second line L2 is connected to the second switch 104, which is illustrated in a first state, connecting the second line L2 to the analog input voltage V_{IN} to be converted (e.g., the analog difference signal Vᵣₛₜ-V_{sig}) to a digital code by the converter 100. In a second state (not shown), the second switch 104 connects the second line L2 to a reference voltage V_{REF}. The second switch 104 is controlled by a second control signal SB output by the successive approximation register 120. The successive approximation register 120 is controlled by a control signal CONTROL from the timing and control circuit 40 (FIG. 1).

FIG. 2 illustrates the switch configuration for sampling the input voltage V_{IN}. In the sampling mode, the analog input voltage V_{IN} is applied to the second line L2 via the second control switch 104 and sampled into the capacitors 106₀, 106₁, 106₂, 106₃, . . . 106_{N-1} through the associated switches 108₀, 108₁, 108₂, 108₃, . . . 108_{N-1}. The first switch 102 is then opened and the associated switches 108₀, 108₁, 108₂, 108₃, . . . 108_{N-1} are set to connect the capacitors 106₀, 106₁, 106₂, 106₃, . . . 106_{N-1} to the ground potential (via switch control signals S₀, S₁, S₂, S₃, . . . S_{N-1}), allowing a voltage equal to −V_{IN} to appear at the inverting input of the comparator 110.

A conversion mode then follows. In the conversion mode, the second switch 104 is connected to the reference voltage V_{REF} and the successive approximation register 120 alternately controls the switching of the associated switches 108₀, 108₁, 108₂, 108₃, . . . 108_{N-1} (by generating the appropriate switch control signals S₀, S₁, S₂, S₃, . . . S_{N-1} as is described in more detail below) between the state connected to the ground potential and the state connecting the second line L2 to the respective associated capacitors 106₀, 106₁, 106₂, 106₃, . . . 106_{N-1}. In doing so, the successive approximation register 120 is searching for a digital code D₀, D₁, . . . D_{N-1} representing the analog input voltage V_{IN}. The switching of the associated switches 108₀, 108₁, 108₂, 108₃, . . . 108_{N-1} is performed as follows and in accordance with the conversion pattern 200 illustrated in FIG. 3.

FIG. 3 represents a conversion pattern 200 used in a column parallel readout architecture having M columns. It should be understood that each column (i.e., columns 0 to M−1) is connected to its own analog-to-digital converter 100 (FIG. 2). The analog-to-digital converters 100 are under the control of the timing and control circuit 40 to convert analog signals in accordance with the pattern 200. Continuing with the above example that the analog-to-digital converter 100 has an N-bit resolution, the pattern 200 illustrates that there are N clock cycles (i.e., cycles 0 to N−1) in the conversion process. The table comprising the pattern 200 uses the notation for the switch control signals S₀, S₁, S₂, S₃, . . . S_{N-1} to indicate which switch control signals are newly activated during that clock cycle; the newly activated switch control signal S₀, S₁, S₂, S₃, . . . S_{N-1} moves the respective associated switches 108₀, 108₁, 108₂, 108₃, . . . 108_{N-1} into the state connecting the reference voltage V_{REF} to one or more of the capacitors 106₀, 106₁, 106₂, 106₃, . . . 106_{N-1} in the manner now described.

Initially, the successive approximation register 120 attempts to determine the most significant bit D₀ of the digital code D₀, . . . , D_{N-1}. To do so, at clock cycle 0, the successive approximation register 120 generates the first switch control signal S₀ to place the first associated switch 108₀ in the state connecting the second line L2 to the first capacitor 106₀. All other associated switches 108₁, 108₂, 108₃, . . . 108_{N-1}, are connected to ground during clock cycle 0. By connecting the first capacitor 106₀ to the reference voltage V_{REF} (via switch 108₀, the second line L2 and switch 104), a voltage equal to V_{REF}/2 is added to the −V_{IN} sampled voltage being applied on the first line L1. The comparator 110 outputs a high comparison decision D to the successive approximation register 120 if the resulting voltage (−V_{IN}+V_{REF}/2) at the inverted input terminal is negative; otherwise, the comparator 110 outputs a low comparison decision D to the successive approximation register 120. The successive approximation register 120 leaves the first switch 108₀ in its current state (i.e., connected to V_{REF}) if the comparison decision D is high; otherwise, the successive approximation register 120 switches the first switch 108₀ to the ground potential state. At the same time, the successive approximation register 120 sets the value of the most significant bit D₀ to either logic one or logic zero based on the comparator decision D.

The successive approximation register 120 moves onto to cycle 1 of the pattern 200, where it generates the second switch control signal S₁ to move the second associated switch 108₁ to the state connecting the second capacitor 106₁ to V_{REF} (via switch 108₁, line L2 and control switch 104). This change in capacitance causes a different voltage (e.g., V_{REF}/4) to be added to the −V_{IN} voltage being applied on the first line L1. Another determination is made (based on the voltage seen at the inverting input of the comparator 110 as described above) and the second most significant bit D₁ of the digital code D₀, . . . , D_{N-1} is set at the end of clock cycle 1. The pattern 200 repeats for all remaining clock cycles (i.e., cycles 2 to N−1). At the end of clock cycle N−1, the successive approximation register 120 has determined and can output the digital code D₀, . . . , D_{N-1} corresponding to the original analog input voltage V_{IN}.

As mentioned above, if the imager 10 is using a column parallel readout architecture and the pixel array 20 comprises M columns, there will be M number of analog-to-digital converters 100 operating simultaneously as shown by the conversion pattern 200 (FIG. 3). The reference voltage V_{REF} must be supported by a buffer since at least M capacitors are switched onto the line (e.g., second line L2) connected to the reference voltage V_{REF} at the same time. For large arrays 20, there can be over 4,000 columns (i.e., M is at least 4,000). For the initial conversion used to determine the most significant bit D₀ of the digital code, the buffer must be able to provide current for a capacitive load equal to M×C. If the capacitance C of the first capacitor 106₀ is 2 pF, for example, the total load on the line connected to V_{REF} is 8 nF. That is, during clock cycle 0 of the conversion process, the V_{REF} line is loaded by M×C=8 nF. In clock cycle 1, the V_{REF} line is loaded by at least 4 nF (since the capacitance should have changed from clock cycle 0 by approximately a power of 2), for clock cycle 2 the V_{REF} line is loaded by at least 2 nF, and so on until clock cycle N−1 (which will have a small load of approximately 0.0039 nF).

Although the capacitive load should reduce with each clock cycle, the initial load and current required for the determination of the most significant bit is relatively high. The high capacitive loading means that a large amount of current is required, which also means that a large buffer is required for the reference voltage V_{REF}. This is undesirable. Furthermore, reducing the amount of capacitance switched onto the line connected to the reference voltage V_{REF}, particularly for the initial conversion used to determine the most significant bit D₀ of the digital code, is desirable for several other reasons including e.g., reducing cycle time and power dissipation during the conversion.

### BRIEF DESCRIPTION OF THE DRAWINGS

FIG. 1 illustrates a block diagram of a CMOS imager.

FIG. 2 illustrates a successive approximation analog-to-digital converter.

FIG. 3 illustrates a table representing a conventional successive approximation analog-to-digital conversion pattern used in a column parallel readout imager architecture.

FIG. 4 illustrates a table representing a successive approximation analog-to-digital conversion pattern used in a column parallel readout imager architecture in accordance with an embodiment disclosed herein.

FIG. 5. illustrates a table representing a successive approximation analog-to-digital conversion pattern used in a column parallel readout imager architecture in accordance with another embodiment disclosed herein.

FIG. 6 illustrates a table representing a successive approximation analog-to-digital conversion pattern used in a column parallel readout imager architecture in accordance with yet another embodiment disclosed herein.

FIG. 7 illustrates a table representing a successive approximation analog-to-digital conversion pattern used in a column parallel readout imager architecture in accordance with another embodiment disclosed herein.

FIG. 8 shows a processor system incorporating at least one imaging device constructed in accordance with an embodiment disclosed herein.

### DETAILED DESCRIPTION

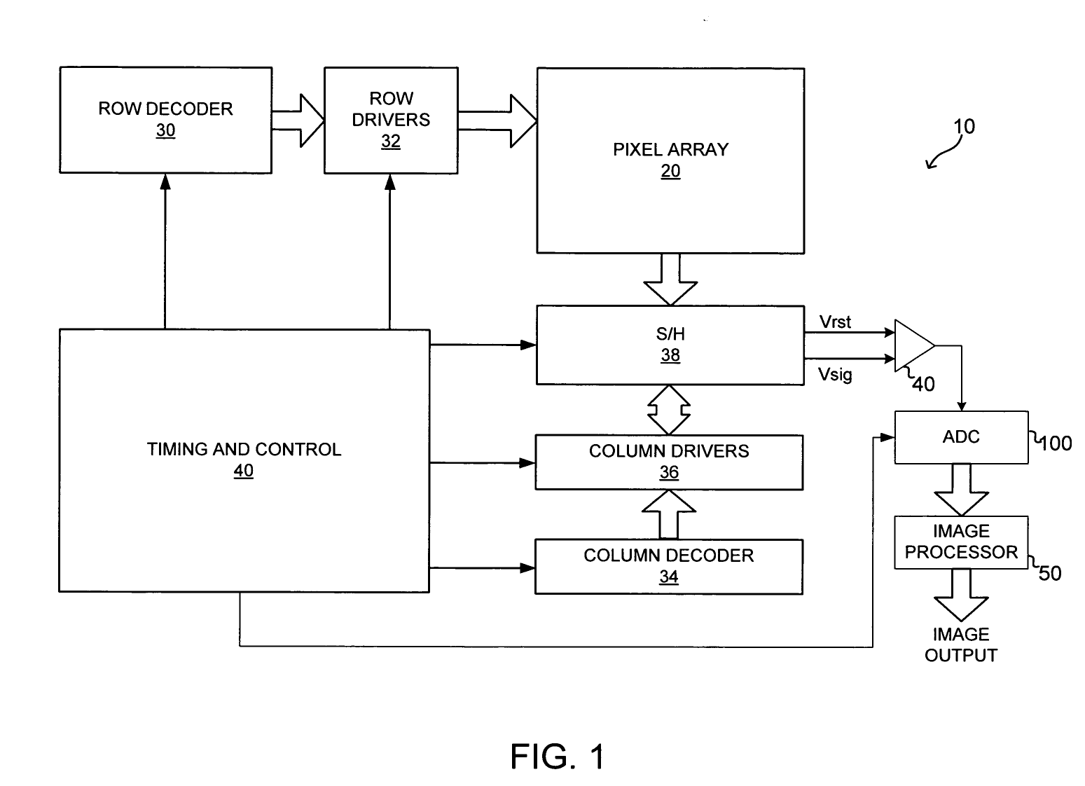

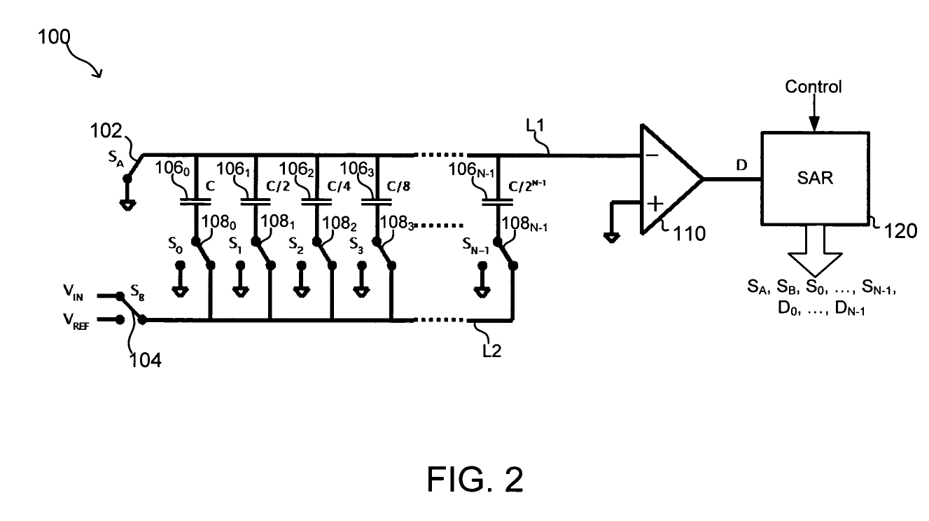

Referring to the figures, where like reference numbers designate like elements, FIG. 4 illustrates a table comprising a successive approximation analog-to-digital conversion pattern 300 used in a column parallel readout imager architecture in accordance with an embodiment disclosed herein. Referring also to FIGS. 1 and 2, it is presumed that the array 20 has M columns and that each column in the array 20 is connected to its own analog-to-digital converter 100. It should be appreciated, however, that an analog-to-digital converter can be connected to more than one column (with switching connecting the analog-to-digital converter to the appropriate column at the appropriate time) and that the embodiments illustrated herein do not require each column to be connected to its own analog-to-digital converter in order to implement the embodiments. In the illustrated example, each analog-to-digital converter 100 has an N bit resolution and is under the control of the timing and control circuit 40 to convert analog signals in accordance with the pattern 300. The table comprising pattern 300 uses the notation for the switch control signals S₀, S₁, S₂, S₃, . . . S_{N-1} to indicate which switch control signals are newly activated during a clock cycle; the newly activated switch control signal S₀, S₁, S₂, S₃, . . . S_{N-1} moves the respective associated switch 108₀, 108₁, 108₂, 108₃, . . . 108_{N-1} into the state connecting the reference voltage V_{REF} to one or more of the capacitors 106₀, 106₁, 106₂, 106₃, . . . 106_{N-1} in the pattern 300.

Initially, it is noted that the columns are organized into groups GROUP 0, . . . GROUP K, . . . , GROUP M/N−1 of N columns each. Likewise, the analog-to-digital converters 100 associated with each column are also considered to be organized into the same groups. Each group GROUP 0, . . . , GROUP K, . . . , GROUP M/N−1 contains entries for N columns denoted as columns 0 to N−1. It should be noted that each group GROUP 0, . . . , GROUP K, . . . , GROUP M/N−1 has a different set of N columns of the M columns in the array 20. It should be appreciated that each group GROUP 0, . . . , GROUP K, . . . , GROUP M/N−1 can contain any number of columns, as desired; it is desirable, however, for the number of columns in the groups to be equal to the resolution of the analog-to-digital converter 100 for optimal performance. It should be noted that the grouping can be accomplished by circuit layout and/or software configuration.

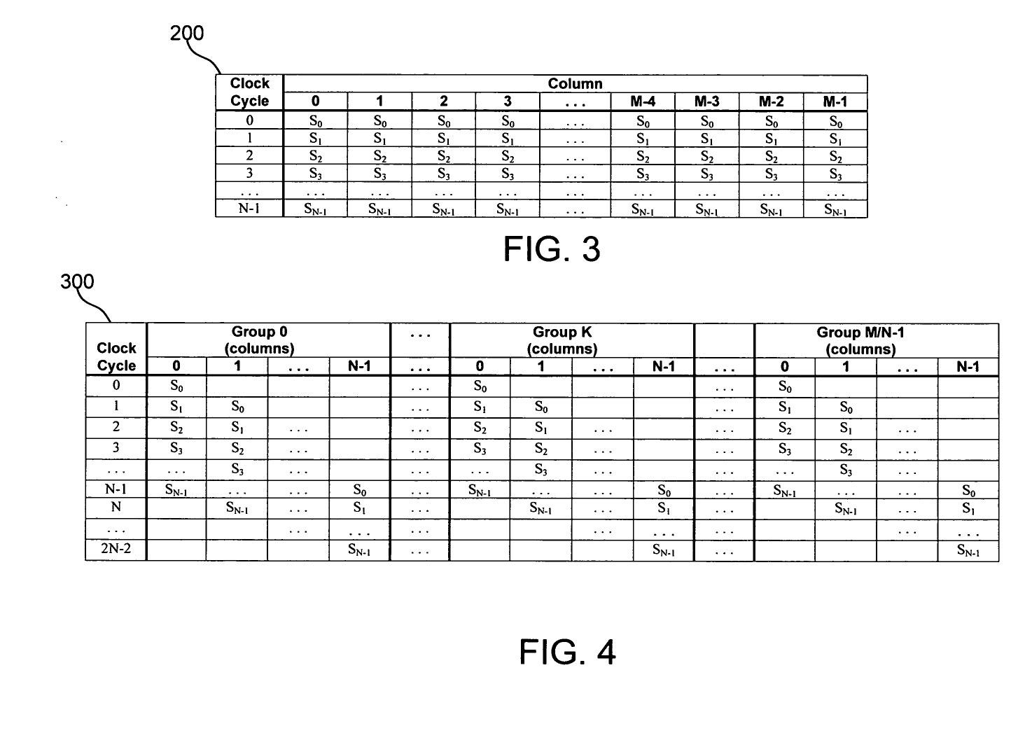

As can be seen, by grouping the columns in this manner, fewer switch control signals S₀, S₁, S₂, S₃, . . . S_{N-1} are activated during many clock cycles, which means that fewer capacitors 106₀, 106₁, 106₂, 106₃, . . . 106_{N-1} are being switched in comparison to the traditional successive approximation pattern 200 (FIG. 3). Although more clock cycles are used than the traditional successive approximation pattern 200, the pattern 300 of the illustrated embodiment reduces the capacitive loading on the line connected to V_{REF} (e.g., line L2) by as much as ⅙^{th} when compared to the capacitive loading experienced in the traditional successive approximation conversion pattern 200.

The illustrated pattern 300 is now described in more detail. Initially, the successive approximation register 120 of the analog-to-digital converter 100 connected to a first column (i.e., column 0) of each group GROUP 0, . . . , GROUP K, . . . , GROUP M/N−1 attempts to determine the most significant bit D₀ of the digital code D₀, . . . , D_{N-1} for that column. To do so, at clock cycle 0, the successive approximation register 120 of the analog-to-digital converter 100 connected to the first column (i.e., column 0) of each group GROUP 0, . . . , GROUP K, . . . GROUP M/N−1 generates the first switch control signal S₀ to place the first associated switch 108₀ in the state connecting the second line L2 to the first capacitor 106₀. All other associated switches 108₁, 108₂, 108₃, . . . 108_{N-}in that analog-to-digital converter 100 are connected to ground during clock cycle 0. In addition, all associated switches 108₀, 108₁, 108₂, 108₃, . . . 108_{N-1} of the analog-to-digital converters 100 connected to the remaining columns (i.e., columns 1 to N−1) of their associated group are connected to ground during clock cycle 0. This means that at clock cycle 0 there are only M/N−1 first capacitors 106₀ connected to V_{REF}, which is a substantial reduction of the capacitive load on the second line L2 when compared to the traditional conversion pattern 200 (FIG. 2).

By connecting the first capacitor 106₀ to the reference voltage V_{REF} (via switch 108₀, the second line L2 and switch 104), a voltage equal to V_{REF}/2 is added to the −V_{IN} sampled voltage being applied on the first line L1. The comparator 110 outputs a high comparison decision D to the successive approximation register 120 if the resulting voltage (−V_{IN}+V_{REF}/2) at the inverted input terminal is negative; otherwise, the comparator 110 outputs a low comparison decision D to the successive approximation register 120. The successive approximation register 120 leaves the first switch 108₀ in its current state (i.e., connected to V_{REF}) if the comparison decision D is high; otherwise, the successive approximation register 120 switches the first switch 108₀ to the ground potential state. At the same time, the successive approximation register 120 sets the value of the most significant bit D₀ to either logic one or logic zero based on the comparator decision D.

For column 0 of each group GROUP 0, . . . , GROUP K, . . . , GROUP M/N−1, the successive approximation register 120 moves onto to cycle 1 of the pattern 300, where it generates the second switch control signal S₁ to move the second associated switch 108₁ to the state connecting the second capacitor 106₁ to V_{REF} (via switch 108₁, line L2 and control switch 104). This change in capacitance causes a different voltage (e.g., V_{REF}/4) to be added to the −V_{IN} voltage being applied on the first line L1. Another determination is made (based on the voltage seen at the inverting input of the comparator 110 as described above) and the second most significant bit D₁ of the digital code D₀, . . . , D_{N-1} is set at the end of clock cycle 1. For column 0 of each group GROUP 0, . . . , GROUP K, . . . , GROUP M/N−1, the pattern 300 repeats for cycles 2 to N−1. At the end of clock cycle N−1, the successive approximation register 120 for column 0 in each group GROUP 0, . . . , GROUP K, . . . , GROUP M/N−1 has determined and can output the digital code D₀, . . . , D_{N-1} corresponding to the original analog input voltage V_{IN} seen at column 0 for each group GROUP 0, . . . , GROUP K, . . . , GROUP M/N−1.

At clock cycle 1, the successive approximation register 120 of the analog-to-digital converters 100 connected to the second column (i.e., column 1) of each group GROUP 0, . . . , GROUP K, . . . , GROUP M/N−1 attempts to determine the most significant bit D₀ of the digital code D₀, . . . , D_{N-1} for that column. Thus, at clock cycle 1, the successive approximation register 120 of the analog-to-digital converter 100 connected to the second column (i.e., column 1) of each group GROUP 0 . . . , GROUP K, . . . , GROUP M/N−1 generates the first switch control signal S₀ to place the first associated switch 108₀ in the state connecting the second line L2 to the first capacitor 106₀. All other associated switches 108₁, 108₂, 108₃, . . . 108_{N-1} for that analog-to-digital converter 100 are connected to ground during clock cycle 1. In addition, all associated switches 108₀, 108₁, 108₂, 108₃, . . . 108_{N-1} of the analog-to-digital converters 100 connected to the remaining columns (i.e., columns 2 to N−1) of their associated group are connected to ground during clock cycle 1. A comparator determination is made (based on the voltage seen at the inverting input of the comparator 110 as described above) and the most significant bit D₀ of the digital code D₀, . . . , D_{N-1} for column 1 of each group is set at the end of clock cycle 1. As mentioned above, while the most significant bit D₀ of the digital code D₀, . . . D_{N-1} for column 1 is being determined, the second most significant bit D₁ of the digital code D₀, . . . D_{N-1} for column 0 is simultaneously being determined.

The pattern 300 continues at clock cycle 2, where the third most significant bit D₂ is determined for column 0 of each group, the second most significant bit D₁ for column 1 is determined for each group and the most significant bit D₀ of the digital code D₀, . . . , D_{N-1} for column 2 of each group is determined in the manner described above. At clock cycle 3, the most significant bit D₀ for the next column (i.e., column 3) in each group is determined while the prior columns make determinations for the next sequential bit in their respective digital codes D₀, . . . D_{N-1}. This pattern continues until the digital codes D₀, . . . , D_{N-1} of all columns of each group GROUP 0, . . . , GROUP K, . . . , GROUP M/N−1 are determined. It should be apparent from the illustrated pattern 300, that each column in a group has its own respective starting clock cycle and ending clock cycle. For example, the conversion determination for all column 0's in each group GROUP 0, . . . , GROUP K, . . . , GROUP M/N−1 starts at clock cycle 0 (for the most significant bit D₀) and ends at clock cycle N−1 (for the least significant bit D_{N-1}) while the conversion determination for all column 1's in each group GROUP 0, . . . , GROUP K, . . . , GROUP M/N−1 starts at clock cycle 1 (for the most significant bit D₀) and ends at clock cycle N (for the least significant bit D_{N-1}), and so on until the conversion determination for all column N−1's in each group GROUP 0, . . . , GROUP K, . . . , GROUP M/N−1 starts at clock cycle N−1 (for the most significant bit D₀) and ends at clock cycle 2N−2 (for the least significant bit D_{N-1}).

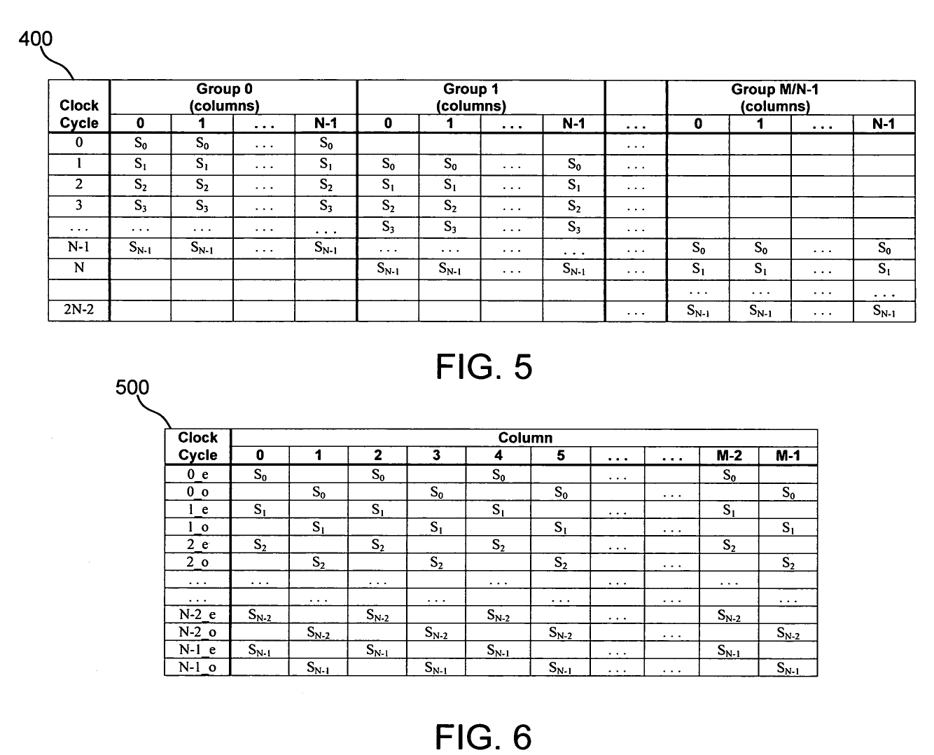

FIG. 5. illustrates a table representing a successive approximation analog-to-digital conversion pattern 400 used in a column parallel readout imager architecture in accordance with another embodiment disclosed herein. The columns in the illustrated pattern 400 are organized into groups GROUP 0, . . . , GROUP K, . . . , GROUP M/N−1 of N columns each. Likewise, in a desired embodiment where each column is connected to its own analog-to-digital converter 100, the analog-to-digital converters 100 associated with each column are also considered to be organized into the same groups. Each group GROUP 0, GROUP 1, . . . , GROUP M/N−1 contains entries for N columns denoted as columns 0 to N−1. It should be noted that each group GROUP 0, GROUP 1, . . . , GROUP M/N−1 has a different set of N columns of the M columns in the array 20. It should be appreciated that each group GROUP 0, GROUP 1, . . . , GROUP M/N−1 can contain any number of columns, as desired; it is desirable, however, for the number of columns in the groups to be equal to the resolution (i.e., N) of the analog-to-digital converter 100 for optimal performance.

As can be seen, by grouping the columns in this manner, fewer switch control signals S₀, S₁, S₂, S₃ . . . S_{N-1} are activated during many clock cycles, which means that fewer capacitors 106₁, 106₂, 106₃, . . . 106_{N-1} are being switched in comparison to the traditional successive approximation pattern 200 (FIG. 3). Although more clock cycles are used than the traditional successive approximation pattern 200, the pattern 400 of the illustrated embodiment reduces the capacitive loading on the line connected to V_{REF} (e.g., line L2) by as much as ⅙^{th} when compared to the capacitive loading experienced in the traditional successive approximation conversion pattern 200.

The illustrated pattern 400 is now described in more detail. Initially, during the first clock cycle (i.e., clock cycle 0), all of the columns within the first group GROUP 0 undergo a conversion determination for their respective most significant bit D₀ of their digital code D₀, . . . , D_{N-1}. That is, all of the analog-to-digital converters 100 of the first group GROUP 0 are operated in parallel during clock cycle 0. Thus, at clock cycle 0, the successive approximation register 120 of the analog-to-digital converters 100 connected to the columns of the first group GROUP 0 generates the first switch control signal S₀ to place the first associated switch 108₀ in the state connecting the second line L2 to the first capacitor 106₀. All other associated switches 108₁, 108₂, 108₃, . . . 108_{N-1} in the analog-to-digital converters 100 within GROUP 0 are connected to ground during clock cycle 0. In addition, all associated switches 108₀, 108₁, 108₂, 108₃, . . . 108_{N-1} of all of the analog-to-digital converters 100 within the remaining groups (i.e., GROUP 1, . . . , GROUP M/N−1) are connected to ground during clock cycle 0. This means that at clock cycle 0 there are only N first capacitors 106₀ connected to V_{REF}, which is a substantial reduction of the capacitive load on the second line L2 when compared to the traditional conversion pattern 200 (FIG. 2).

At the end of clock cycle 0, all of the most significant bits D₀ are determined for all of the columns within the first group GROUP 0. Next, at clock cycle 1, the analog-to-digital converters 100 of the first group GROUP 0 operate in parallel to determine their respective second most significant bit D₁ of their digital code D₀, . . . , D_{N-1}. Thus, at clock cycle 1, the successive approximation register 120 of the analog-to-digital converters 100 connected to the columns of the first group GROUP 0 generates the second switch control signal S₁ to place the second associated switch 108₁ in the state connecting the second line L2 to the second capacitor 106₁.

At the same time, the analog-to-digital converters 100 of the second group GROUP 1 are operated in parallel to determine their respective most significant bit D₀. Thus, at clock cycle 1, the successive approximation register 120 of the analog-to-digital converters 100 connected to the columns of the second group GROUP 1 generates the first switch control signal S₀ to place the first associated switch 108₀ in the state connecting the second line L2 to the first capacitor 106₀. During the next clock cycle (i.e., clock cycle 2), the next group begins its conversion process for its most significant bit D₀ (by setting S₀), while the first group GROUP 0 begins its conversion process for the third most significant bit D₂ (by setting S₂) and GROUP 1 begins its conversion process for its second most significant bit D₁ (by setting S₁). This pattern 400 repeats until the least significant bits D_{N-1} for each column of the last group GROUP M/N−1 are determined at clock cycle 2N−2.

It should be apparent from the illustrated pattern 400, that each group GROUP 0, GROUP 1, . . . , GROUP M/N−1 has its own respective starting clock cycle and ending clock cycle. As can be seen, each group begins its conversion one clock cycle after the prior group and that the conversion is otherwise essentially the same for each group (i.e., similar to pattern 200). For example, the conversion determination for all columns in the first group GROUP 0 starts at clock cycle 0 (for the most significant bit D₀) and ends at clock cycle N−1 (for the least significant bit D_{N-1}); the conversion determination for all columns in the second group GROUP 1 starts at clock cycle 1 (for the most significant bit D₀) and ends at clock cycle N (for the least significant bit D_{N-1}); and so on until the conversion determination for all columns in the last group GROUP M/N−1 starts at clock cycle N−1 (for the most significant bit D₀) and ends at clock cycle 2N−2 (for the least significant bit D_{N-1}).

FIG. 6 illustrates a table representing a successive approximation analog-to-digital conversion pattern 500 used in a column parallel readout imager architecture in accordance with yet another embodiment disclosed herein. In this pattern 500, columns are not grouped as they were in the prior embodiments. Instead, they are considered to be grouped having odd numbered columns processed during odd clock cycles (e.g., clock cycle 0_o) and even numbered columns processed during even clock cycles (e.g., clock cycle 0_e). The illustrated pattern 500 uses more clock cycles than the traditional pattern 200, but fewer columns are processed during the clock cycles, which reduces the capacitive loading on the line connected to V_{REF} (e.g., line L2). Although more cycles are needed, the reduced capacitance leads to quicker cycles, which helps compensate for the increased number of required cycles.

In the illustrated example, the first clock cycle is an even clock cycle for clock cycle 0. It should be appreciated that the first clock cycle could be an odd clock cycle if so desired. As can be seen, in the first even clock cycle 0_e, all of the even numbered columns (i.e., columns 0, 2, 4, . . . , M−2) undergo a conversion to determine their respective most significant bit D₀. To do so, the successive approximation register 120 of the analog-to-digital converters 100 connected to even columns (i.e., columns 0, 2, 4, . . . , M−2) generates the first switch control signal S₀ to place the first associated switch 108₀ in the state connecting the second line L2 to the first capacitor 106₀. All other associated switches 108₁, 108₂, 108₃, . . . 108_{N-1} in the analog-to-digital converters 100 connected to even columns (i.e., columns 0, 2, 4, . . . , M−2) are connected to ground during clock cycle 0_e. In addition, all associated switches 108₀, 108₁, 108₂, 108₃, . . . 108_{N-1} of all of the analog-to-digital converters 100 connected to odd columns (i.e., columns 1, 3, 5, . . . , M−1) are connected to ground during clock cycle 0_e.

In the first odd clock cycle 0_o, all of the odd numbered columns (i.e., columns 1, 3, 5, . . . , M−1) undergo a conversion to determine their respective most significant bit D₀. That is, the successive approximation register 120 of the analog-to-digital converters 100 connected to odd columns (i.e., columns 1, 3, 5, . . . , M−1) generates the first switch control signal S₀ to place the first associated switch 108₀ in the state connecting the second line L2 to the first capacitor 106₀. All other associated switches 108₁, 108₂, 108₃, . . . 108_{N-1} in the analog-to-digital converters 100 connected to odd columns (i.e., columns 1, 3, 5, . . . , M−1) are connected to ground during clock cycle 0_o. In addition, all associated switches 108₀, 108₁, 108₂, 108₃, . . . 108_{N-1} of all of the analog-to-digital converters 100 connected to the even columns (i.e., columns 0, 2, 4, . . . , M−2) are connected to ground during clock cycle 0_o.

The pattern 500 alternates even and odd clock cycles (i.e., 1_e, 1_o, 2_e, 2_o, . . . N−2_e, N−2_o, N−1_e, N−1_o). Each pair of even and odd clock cycles is used to determine the next most significant bit. For example, in clock cycles 1_e, 1_o, the second most significant bit D₁ for the even and odd columns, respectively, are determined by setting the second switch control signal S₁ to place the second associated switch 108₁ in the state connecting the second line L2 to the second capacitor 106₁. Likewise, in clock cycles 2_e, 2_o, the third most significant bit D₂ for the even and odd columns, respectively, are determined by setting the third switch control signal S₂ to place the third associated switch 108₂ in the state connecting the second line L2 to the third capacitor 106₂. The pattern 500 continues in this matter until clock cycles N−1_e, N−1_o, where the least significant bit D_{N-1} for the even and odd columns, respectively, are determined by setting the last switch control signal S_{N-1} to place the last associated switch 108_{N-1} in the state connecting the second line L2 to the last capacitor 106_{N-1}.

It should be apparent from the illustrated pattern 500, that conversion for each even numbered column (i.e., columns 0, 2, 4, . . . , M−2) has the same starting and ending clock cycles and that the conversion for each odd numbered column (i.e., columns 1, 3, 5, . . . , M−1) has the same starting and ending clock cycles, which are different than the even clock cycles. For example, the conversion determination for all even numbered columns starts at clock cycle 0_e (for the most significant bit D₀) and ends at clock cycle N−1_e (for the least significant bit D_{N-1}); the conversion determination for all odd numbered columns starts at clock cycle 0_o (for the most significant bit D₀) and ends at clock cycle N−1_o (for the least significant bit D_{N-1}).

It should be appreciated that the pattern 500 could also be modified by grouping even and odd columns into respective groups similar to the groups illustrated in FIGS. 4 and 5. The groups could then be processed as shown in FIG. 4 or 5, but using even and odd clock cycles to perform the processing for even columns only and then odd columns only. This would use twice as many clock cycles as those used in FIGS. 4 and 5, but would process half as many columns per cycle.

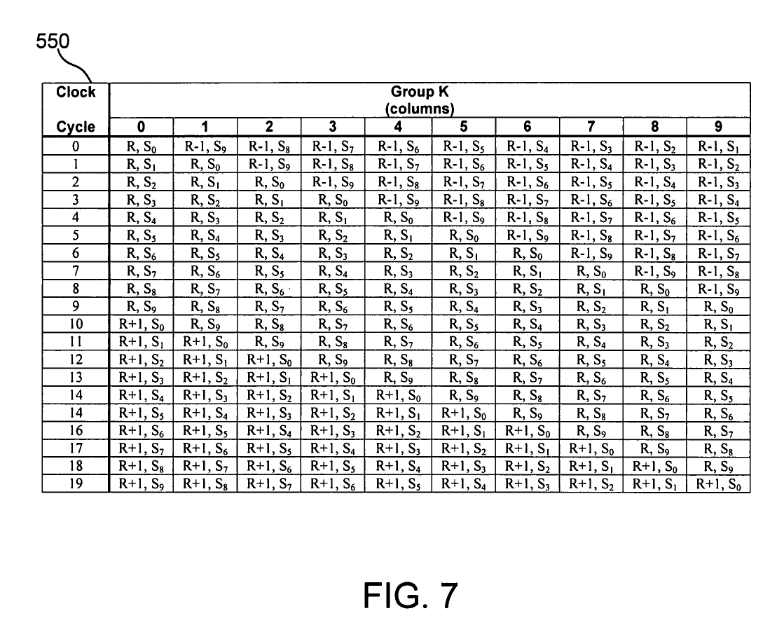

FIG. 7 illustrates a table representing a successive approximation analog-to-digital conversion pattern 550 used in a column parallel readout imager architecture in accordance with another embodiment disclosed herein. The table comprising pattern 550 uses the notation for the switch control signals S₀, S₁, S₂, S₃, . . . S_{N-1} to indicate which switch control signals are newly activated during a clock cycle; the newly activated switch control signal S₀, S₁, S₂, S₃, . . . S_{N-1} moves the respective associated switch 108₀, 108₁, 108₂, 108₃, . . . 108_{N-1} into the state connecting the reference voltage V_{REF} to one or more of the capacitors 106₀, 106₁, 106₂, 106₃, . . . 106_{N-1} in the pattern 500. The table also uses the notation R to indicate the current row of an imager that is being converted, R−1 to indicate that a prior row is being converted and R+1 to indicate that the next row of the imager is being converted.

Initially, it is noted that the columns are organized into groups e.g., GROUP K of N columns each. In the FIG. 7 example, the resolution of the analog-to-digital converter is ten, so N is ten. Therefore, each group contains ten columns (i.e., columns 0-9). Likewise, the analog-to-digital converters 100 associated with each column are also considered to be organized into the same groups. Thus, like the grouping used in the patterns 300, 400 illustrated in FIGS. 4 and 5, each group has a different set of N (e.g., 10) columns of the M columns in the array 20. It should be appreciated that each group GROUP 0, . . . , GROUP K, . . . , GROUP M/N−1 can contain more or less than ten columns, as desired; it is desirable, however, for the number of columns in the groups to be equal to the resolution of the analog-to-digital converter 100 for optimal performance. It should be noted that the grouping can be accomplished by circuit layout and/or software configuration.

The pattern 550 is designed to fill in the blank portions of pattern 300 (FIG. 4). That is, by converting analog signals from a current row R and a prior row R−1 at the same time (and eventually moving on to the next row R+1), the pattern 550 causes analog-to-digital converters 100 for every column to be operated in parallel. As will become apparent, since the capacitive load is varied (and less than the typical pattern 200), the pattern 550 is advantageous over the typical conversion pattern 200. The illustrated pattern 500 is now described in more detail with reference to only GROUP K. It should be appreciated, however, that all groups (i.e., groups 0, 1, . . . , M/N−1) undergo the same processing at the same time. The illustrated pattern 550 only shows one group for clarity and convenience purposes.

During clock cycle 0, the successive approximation register 120 of the analog-to-digital converter 100 connected to the first column (i.e., column 0) of each group e.g., GROUP GROUP K attempts to determine the most significant bit D₀ of the digital code D₀ . . . , D_{N-1} for that column. Thus, at clock cycle 0, the successive approximation register 120 of the analog-to-digital converter 100 connected to column 0 of each group generates the first switch control signal S₀ to place the first associated switch 108₀ in the state connecting the second line L2 to the first capacitor 106₀. All other associated switches 108₁, 108₂, 108₃, . . . 108_{N-1} in that analog-to-digital converter 100 are connected to ground during clock cycle 0. So far, the pattern 550 is similar to pattern 300.

However, unlike pattern 300, during clock cycle 0 the analog-to-digital converters 100 connected to the remaining columns in the group are undergoing a conversion of a different bit in their own respective digital code; in the illustrated pattern 550, the conversions are for analog signals that were input from the prior row R−1. That is, the column 1 analog-to-digital converter 100 converts the least significant bit D₉ of its code for row R−1 (by generating switch control signal S₉), column 2 converts its second least significant bit D₈ (by generating switch control signal S₈), and so on, with column 9 converting its second most significant bit D₁ (by generating switch control signal S₁). Thus, depending on the column, a different bit is being converted, which means that different associated switches 108₀, 108₁, 108₂, 108₃, . . . 108_{N-1} are being closed to connect different capacitors 106₀, 106₁, 106₂, 106₃, . . . 106_{N-1} to V_{REF} during clock cycle 0.

Continuing with the illustrated example, it can be seen that at clock cycle 1, the column 0 successive approximation register 120 generates the second switch control signal S₁ to move the second associated switch 108₁ to the state connecting the second capacitor 106₁ to V_{REF} to determine the value of the second most significant bit D₁. Column 1, on the other hand, begins a conversion for its most significant bit D₀ for the current row R (by generating switch control signal S₀), while the remaining columns (i.e., columns 2-9) convert a different bit from the prior row R−1 (by generating different switch control signals S₉-S₂). The pattern 550 repeats in this matter for the next 8 clock cycles, where at clock cycle 9 the column 0 analog-to-digital converter 100 determines its least significant bit D₉ of its code for the current row R (by generating control signal S₀). Also at clock cycle 9, all columns are operating on the current row R. At clock cycle 10, column 0 of each group begins a new conversion process starting with the most significant bit D₀ for the next row R+1 (which has already been sampled and held by this time). The other columns operate on different bits (by generating different control signals S₉-S₁) for the current row R.

It should be apparent from the illustrated pattern 550, that each column in a group has its own respective starting clock cycle and ending clock cycle for the current row R. In periods where the columns are not operating on the current row R, they are operating on the prior row R−1 or the next row R+1.

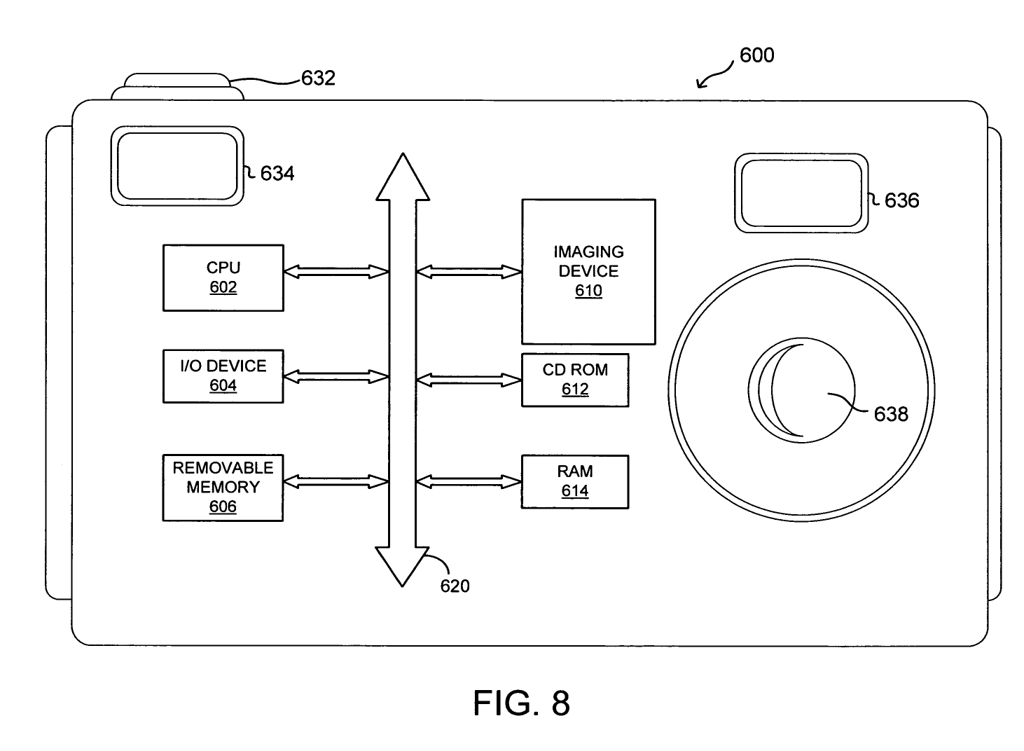

FIG. 8 shows a processor system 600 incorporating at least one imaging device 610 constructed and operated in accordance with an embodiment disclosed herein. The processor system 600 could, for example be a camera system comprising a shutter release button 632, a view finder 634, a flash 636 and a lens system 638 for focusing an image on the pixel array of the imaging device 610. The system 600 generally also comprises a central processing unit (CPU) 602, for example, a microprocessor for controlling functions and which communicates with one or more input/output devices (I/O) 604 over a bus 620. The CPU 602 also exchanges data with random access memory (RAM) 614 over the bus 620, typically through a memory controller. The camera system may also include peripheral devices such as a removable memory 606, which also communicates with CPU 602 over the bus 620. In the case of a computer system, the system 600 could also include a CD ROM drive 612. Other processor systems which may employ imaging devices 610 besides cameras, include computers, PDAs, cell phones, scanners, machine vision systems, and other systems requiring imaging applications.

It should be appreciated that any of the above described embodiments can use analog-to-digital converters that are connected to more than one column each. That is, the same analog-to-digital converter can be switched between multiple columns when analog signals of the appropriate column are required to be converted. All that is required is to practice the embodiments is that the analog-to-digital converters be connected to the columns illustrated in the patterns during the correct clock cycles.

The above description and drawings illustrate various embodiments It should be appreciated that modifications, though presently unforeseeable, of these embodiments that can be made without departing from the spirit and scope of the invention which is defined by the following claims.

What is claimed as new and desired to be protected by Letters Patent of the United States is:

1. A method of operating an imaging device comprising a pixel array having M columns connected to column parallel analog-to-digital converters, the analog-to-digital converters having an N-bit resolution, the method comprising:
grouping each column into one of a plurality of groups;
simultaneously inputting analog signals from each column of the pixel array; and
converting the analog signals into respective N-bit digital codes associated with each column, the conversion of the analog signals into the N-bit digital codes being performed in accordance with a conversion pattern whereby, in each conversion cycle of the pattern, different portions of the N-bit digital codes are determined based on the group the associated column is within.

2. The method of claim 1, wherein the grouping step comprises grouping the M columns into M/N groups of N columns.

3. The method of claim 2, wherein the converting step comprises determining a first bit position of the respective digital codes for each first column in each group while determining a second bit position of the respective digital codes for each second column in each group during a same clock cycle.

4. The method of claim 2, wherein the converting step comprises:
beginning a conversion process for each first column within each group during a first clock cycle; and
beginning a conversion process for a second column within each group during a second clock cycle.

5. The method of claim 4, wherein for each subsequent clock cycle, the converting step begins a conversion process for the next sequential column in each group.

6. The method of claim 2, wherein the converting step comprises determining the same bit position of the respective digital codes for each column in a group, each group determining a different bit than the other groups during the same clock cycle.

7. The method of claim 2, wherein the converting step determines different bit positions of the respective digital codes for each column within a group during the same clock cycle.

8. The method of claim 7, wherein at least one column within each group determines a bit from a current row of signals and at least one column within each group determines a bit from a prior row of signals.

9. The method of claim 1, wherein the grouping step groups the columns into a first group comprising odd numbered columns and a second group comprising even numbered columns.

10. The method of claim 9, wherein the converting step comprises:
determining a respective first bit of the digital codes associated with the columns of the first group in a first clock cycle; and
determining a respective first bit of the digital codes associated with the columns of the second group in a second clock cycle.

11. (canceled)

12. A method of operating an imaging device having a pixel array, the method comprising:
analog-to-digital converting pixel signals associated with columns of the array into respective multi-bit digital signals using successive approximation in which each bit of each multi-bit digital signal is successively determined and in which not all columns have their respective pixel signals converted at a same bit position of the multi-bit digital signal at the same time.

13. An analog-to-digital converter comprising:
a plurality of successive approximation analog-to-digital converter circuits, each circuit being configured to input analog signals from a respective column of pixels and to convert the analog signals into a respective N-bit digital code, each circuit being organized into one of a plurality of groups; and
a controller adapted to control the conversion performed by the analog-to-digital converter circuits in accordance with a conversion pattern whereby, in each conversion cycle of the pattern, different portions of the N-bit digital codes are determined based on the group the associated analog-to-digital converter circuit is within.

14. The analog-to-digital converter of claim 13, wherein the number of columns is an integer M and the plurality of successive approximation analog-to-digital converter circuits are grouped into M/N groups of N columns.

15. The analog-to-digital converter of claim 14, wherein the plurality of successive approximation analog-to-digital converter circuits are controlled to determine a first bit position of the respective digital codes for each first column in each group while determining a second bit position of the respective digital codes for each second column in each group during a same clock cycle.

16. The analog-to-digital converter of claim 14, wherein the plurality of successive approximation analog-to-digital converter circuits are controlled to begin a conversion process for each first column within each group during a first clock cycle and to begin a conversion process for a second column within each group during a second clock cycle.

17. The analog-to-digital converter of claim 16, wherein for each subsequent clock cycle, the plurality of successive approximation analog-to-digital converter circuits are controlled to begin a conversion process for the next sequential column in each group.

18. The analog-to-digital converter of claim 14, wherein the plurality of successive approximation analog-to-digital converter circuits are controlled to determine the same bit position of the respective digital codes for each column in a group, each group determining a different bit than the other groups during the same clock cycle.

19. The analog-to-digital converter of claim 14, wherein the plurality of successive approximation analog-to-digital converter circuits are controlled to determine different bit positions of the respective digital codes for each column within a group during the same clock cycle.

20. The analog-to-digital converter of claim 19, wherein the plurality of successive approximation analog-to-digital converter circuits are controlled such that at least one column within each group determines a bit from a current row of signals and at least one column within each group determines a bit from a prior row of signals.

21. The analog-to-digital converter of claim 13, wherein the plurality of successive approximation analog-to-digital converter circuits are organized into a first group comprising odd numbered columns and a second group comprising even numbered columns.

22. The analog-to-digital converter of claim 21, wherein the plurality of successive approximation analog-to-digital converter circuits are controlled to determine a respective first bit of the digital codes associated with the columns of the first group in a first clock cycle and determine a respective first bit of the digital codes associated with the columns of the second group in a second clock cycle.

23. The analog-to-digital converter of claim 13, wherein each successive approximation analog-to-digital converter comprises:
a binary weighted capacitive circuit switchably connected to the analog signals from the respective column and a reference voltage and having an output connected to an input of a comparator, said binary weighted capacitive circuit having a plurality of capacitive elements and associated switches for switching in the capacitive elements to the output; and
a control register for controlling the associated switches based on the conversion pattern.

24. The analog-to-digital converter of claim 23, wherein each control register controls its associated binary weighted capacitive circuit to determine different portions of the N-bit digital code by controlling which capacitive elements are switched to the output.

25. An imaging device comprising:
an array of pixels organized into M columns, the columns being grouped into one of a plurality of groups;
a timing and control circuit; and
a column parallel analog-to-digital converter coupled to the timing and control circuit and to the columns of the array for inputting analog signals from the colunms and converting the analog signals into respective N-bit digital codes, the analog-to-digital converter comprising a plurality of conversion circuits, each circuit comprising:
a binary weighted capacitive circuit switchably connected to the analog signals input from the respective column and a reference voltage, the binary weighted capacitive circuit having an output connected to an input of a decision circuit, said binary weighted capacitive circuit having a plurality of capacitive elements and associated switches for switching in the capacitive elements to the output and a control register for controlling the associated switches, and
control logic connected to the decision circuit and the switches, said control logic being adapted to apply control signals to the switches to determine different bit positions of the digital code,
wherein the timing and control circuit controls the analog-to-digital converter such that each group has the same conversion pattern and each column in a group has its own respective conversion starting clock cycle and ending clock cycle.

26. An imaging device comprising:
an array of pixels organized into M columns, the columns being grouped into one of a plurality of groups;
a timing and control circuit; and
a column parallel analog-to-digital converter coupled to the timing and control circuit and to the columns of the array for inputting analog signals from the columns and converting the analog signals into respective N-bit digital codes, the analog-to-digital converter comprising a plurality of conversion circuits, each circuit comprising:
a binary weighted capacitive circuit switchably connected to the analog signals input from the respective column and a reference voltage, the binary weighted capacitive circuit having an output connected to an input of a decision circuit, said binary weighted capacitive circuit having a plurality of capacitive elements and associated switches for switching in the capacitive elements to the output and a control register for controlling the associated switches, and
control logic connected to the decision circuit and the switches, said control logic being adapted to apply control signals to the switches to determine different bit positions of the digital code,
wherein the timing and control circuit controls the analog-to-digital converter such that each group has its own respective starting clock cycle and ending clock cycle.

27. (canceled)

28. (canceled)
